(19) United States
(12) Patent Application Publication
(10) Pub. No.: US 2023/0211446 A1
(43) Pub. Date: Jul. 6, 2023

(54) MACHINE TOOL

(71) Applicant: FANUC CORPORATION, Minamitsuru-gun (JP)

(72) Inventor: Hiroshi MINAMI, Minamitsuru-gun, Yamanashi-ken (JP)

(21) Appl. No.: 17/927,811

(22) PCT Filed: May 31, 2021
(86) PCT No.: PCT/JP2021/020618

§ 371 Date: Nov. 25, 2022

(30) Foreign Application Priority Data
Jun. 2, 2020 (JP) 2020-095979

(51) Int. Cl. B23Q 11/00; B23Q 1/72

(52) U.S. Cl. CPC B23Q 11/0017; B23Q 1/72; B23Q 2220/006

(57) ABSTRACT

A machine tool includes: a servo motor that changes the opening degree of an opening/closing valve; a current acquisition unit that acquires driving current outputted to a drive motor for driving a slider; and a motor control unit that adjusts the pressure of a compressed fluid in a fluid balancer by controlling the servo motor on the basis of the driving current.

### TECHNICAL FIELD

The present invention relates to a machine tool including a slider movable on a guide shaft extending along a gravity direction.

### BACKGROUND ART

A spindle head that supports a spindle to and from which a tool can be attached and detached, a table for mounting a workpiece thereon, or the like is attached to a slider of a machine tool. Therefore, the weight of the slider tends to increase. As such, a balancer device that reduces the weight of the slider may be provided in the machine tool.

For example, in a machine tool disclosed in JP 2005-138189 A, there is disclosed an air balancer that pneumatically supports a slider (mechanical structure) that moves up and down in a vertical direction. The air balancer has an air pressure chamber. Compressed air is introduced into the air pressure chamber from a regulator. The compressed air is set according to the weight of the slider (mechanical structure).

### SUMMARY OF THE INVENTION

However, the weight of the slider may vary. For example, when the spindle head is attached to the slider, the weight of the slider may change due to exchange of a tool attached to the spindle of the spindle head. Further, in a case where a table is attached to the slider, the weight of the slider may change due to addition or exchange of a workpiece (object to be machined) mounted on the table.

In JP 2005-138189 A, there is no description about setting of the pressure of the compressed air when the weight of the slider (mechanical structure) changes. When the pressure of the compressed air is not changed in accordance with the change in the weight of the slider, there is a concern that the slider cannot smoothly move. In particular, in a precision machine tool that machines a workpiece with relatively high machining accuracy, it is important to move the slider smoothly.

Therefore, an object of the present invention is to provide a machine tool capable of smoothly moving a slider.

According to an aspect of the present invention, there is provided

a machine tool including a slider configured to be movable on a guide shaft that extends along a gravity direction, the machine tool including:

a fluid balancer configured to reduce a weight of the slider using a compressed fluid;

an opening/closing valve provided in a flow path for the compressed fluid supplied from a fluid supply source to the fluid balancer and configured to open and close the flow path;

a servo motor configured to chance an opening degree of the opening/closing valve;

a current acquisition unit configured to acquire a drive current output to a drive motor configured to drive the slider; and

a motor control unit configured to adjust a pressure of the compressed fluid inside the fluid balancer by controlling the servo motor based on the drive current.

According to the present invention, the pressure inside the fluid balancer is adjusted based on the drive current which tends to change in accordance with the weight of the slider, and thus the load on the slider can be reduced in accordance with the weight of the slider. As a result, the slider can be smoothly moved.

### BRIEF DESCRIPTION OF DRAWINGS

FIG. 1 is a schematic view showing a machine tool;

FIG. 2 is a schematic view showing a fluid balancer;

FIG. 3 is a block diagram showing a configuration of a control device;

FIG. 4 is a block diagram showing a configuration of a control device according to a first modification;

FIG. 5 is a block diagram showing a configuration of a control device according to a second modification; and

FIG. 6 is a block diagram showing a configuration of a control device according to a third modification.

### DETAILED DESCRIPTION OF THE INVENTION

The present invention will be detailed hereinbelow by describing a preferred embodiment with reference to the accompanying drawings.

### Embodiment

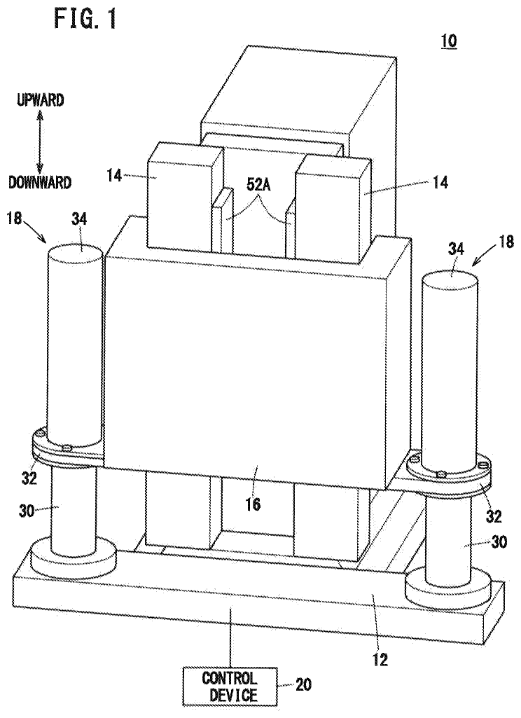

FIG. 1 is a schematic view showing a machine tool 10. FIG. 1 indicates an up-down direction. The downward direction is a direction in which gravity acts, and the upward direction is a direction opposite to the direction in which gravity acts.

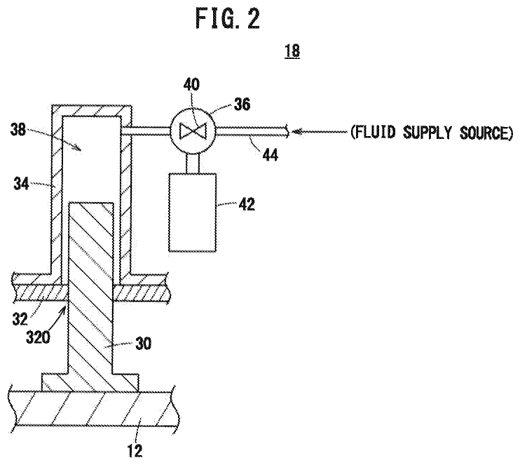

As shown in FIGS. 1 and 2, the machine tool 10 includes a base 12, a guide shaft 14, a slider 16, a fluid balancer 18, and a control device 20.

The base 12 is a base on which the guide shaft 14 and the fluid balancer 18 are installed.

The guide shaft 14 serves for guiding the slider 16. The guide shaft 14 is fixed to the base 12 and extends in the up-down direction. The guide shaft 14 may extend in the vertical direction, or may extend in a direction inclined with respect to the vertical direction. Further, the number of the guide shafts 14 may be one or more. When there are a plurality of guide shafts 14, the plurality of guide shafts 14 are arranged in parallel. In the present embodiment, the number of guide shafts 14 is two.

The slider 16 is movable along the guide shaft 14. A machine component such as a spindle head that rotatably supports a spindle to and from which a tool can be attached and detached or a table to which a workpiece is fixed is attached to the slider 16.

The fluid balancer 18 reduces the weight of the slider 16. When no mechanical component is attached to the slider 16, the weight of the slider 16 is its own weight of the slider 16. In the case where a mechanical component is attached to the slider 16, the weight of the slider 16 is the sum of the weight of the slider 16 and the weight of the mechanical component.

The number of the fluid balancers 18 may be one or more. In the present embodiment, the number of the fluid balancers 18 is two. The two guide shafts 14 are arranged between the two fluid balancers 18. Since the two fluid balancers 18 have the same structure, the structure of one of the fluid balancers 18 will be described below. FIG. 2 is a schematic view showing the fluid balancer 18. The fluid balancer 18 includes a shaft 30, a base member 32, a cylinder 34, and a regulator 36. In FIG. 2, the shaft 30, the base member 32, and the cylinder 34 are shown in cross-section along the up-down direction.

The shaft 30 is fixed to the base 12 and is provided along the guide shaft 14 (see FIG. 1). In the present embodiment, the shaft 30 is spaced from the guide shaft 14.

The base member 32 is fixed to the slider 16 (see FIG. 1). The base member 32 moves together with the slider 16. The base member 32 is formed in, for example, a plate shape. The base member 32 extends substantially horizontally toward the shaft 30. One end of the base member 32 is fixed to the slider 16. A through hole 320 is formed in the base member 32. The shaft 30 is inserted into the through hole 320.

The cylinder 34 is fixed to the base member 32. The cylinder 34 is disposed on one opening side of the through hole 320 formed in the base member 32. The shaft 30 protruding from the one opening side of the through hole 320 is inserted into the cylinder 34.

The regulator 36 regulates the pressure inside a fluid chamber 38. The fluid chamber 38 is formed between the shaft 30 and the cylinder 34. The regulator 36 may collectively regulate the pressure inside each of the fluid chambers 38 of the two fluid balancers 18. Further, one regulator 36 may be provided for each of the two fluid balancers 18. The regulator 36 provided in each of the two fluid balancers 18 individually adjusts the pressure inside the fluid chamber 38 of the corresponding fluid balancer 18. The regulator 36 includes an opening/closing valve 40 and a servo motor 42.

The opening/closing valve 40 is provided in a flow path 44 from a fluid supply source of the compressed fluid to the fluid chamber 38. The opening/closing valve 40 opens and closes the flow path 44. The fluid supply source may be a compressor or the like. The compressed fluid is a fluid that has been compressed. Examples of the fluid include a gas such as air or nitrogen, and a liquid such as oil. The servo motor 42 is coupled to the opening/closing valve 40. The servo motor 42 changes the opening degree of the opening/closing valve 40. When the opening degree is “0”, the opening/closing valve 40 is in a closed state. When the opening degree is larger than “0”, the opening/closing valve 40 is in an open state. When the opening/closing valve 40 is in the open state, the compressed fluid is supplied from the fluid supply source to the fluid chamber 38. Part of the compressed fluid supplied to the fluid chamber 38 is discharged from a gap between the shaft 30 and the cylinder 34.

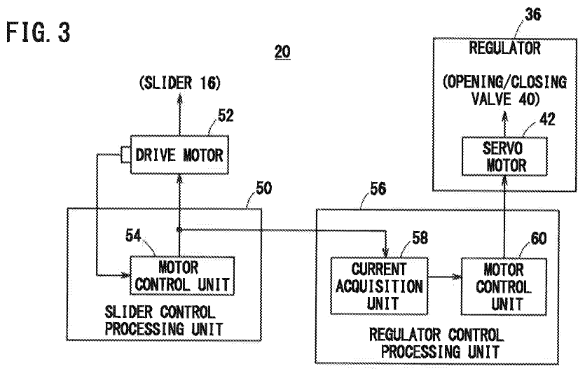

FIG. 3 is a block diagram showing the configuration of the control device 20. The control device 20 includes a slider control processing unit 50. The slider control processing unit 50 controls the slider 16. The slider control processing unit 50 includes a motor control unit 54. The motor control unit 54 controls a drive motor 52.

The drive motor 52 may be a linear motor or a servo motor. In the present embodiment, the drive motor 52 is a linear motor. Magnets 52A (refer to FIG. 1) of the drive motor 52 are provided one for each of the two guide shafts 14. The magnets 52A provided on the respective two guide shafts 14 face each other. Each of the magnets 52A is arranged along the guide shaft 14. A coil (not shown) of the drive motor 52 is disposed between the magnets 52A facing each other. The coil of the drive motor 52 is fixed to the slider 16.

The motor control unit 54 performs feedback control of the drive motor 52 based on a machining program. The machining program is a program for machining a workpiece by using a tool. The motor control unit 54 adjusts a drive current so as to reduce the difference between the current value measured by the drive motor 52 and a target value. The motor control unit 54 rotates the drive motor 52 in the positive direction or the negative direction by outputting the adjusted drive current to the drive motor 52.

When the drive motor 52 is rotated in the positive direction (or the negative direction), the slider 16 is moved upward. When the drive motor 52 is rotated in the negative direction (or the positive direction), the slider 16 is moved downward. When the slider 16 moves upward or downward, the base member 32 fixed to the slider 16 and the cylinder 34 fixed to the base member 32 move together with the slider 16 (see FIG. 1 or FIG. 2). That is, the fluid balancer 18 expands and contracts in conjunction with movement of the slider 16.

The control device 20 includes a regulator control processing unit 56. The regulator control processing unit 56 controls the regulator 36. The regulator control processing unit 56 includes a current acquisition unit 58 and a motor control unit 60. The current acquisition unit 58 acquires a drive current output from the motor control unit 54 to the drive motor 52. The motor control unit 60 controls the servo motor 42.

The motor control unit 60 adjusts the pressure of the compressed fluid inside the fluid chamber 38 of the fluid balancer 18 by controlling the servo motor 42 of the regulator 36 based on the drive current acquired by the current acquisition unit 58. The motor control unit 60 controls the servo motor 42 so that the difference between the drive current acquired by the current acquisition unit 58 and a target value becomes small.

The target value with which the motor control unit 60 compares the drive current is the same as the target value with which the motor control unit 54 compares the current value. The motor control unit 60 may acquire the target value to be compared with the drive current from the motor control unit 54. The target value may be set in the motor control unit 60 in advance.

The magnitude of the drive current output to the drive motor 52 tends to change in accordance with the weight of the slider 16. The motor control unit 60 controls the servo motor 42 so as to reduce the difference between the drive current and the target value. Therefore, even if the weight of the slider 16 changes, the load on the slider 16 can be reduced by using the fluid pressure corresponding to the changed weight. As a result, the slider 16 can be smoothly moved.

When the slider 16 moves upward, the drive current output to the drive motor 52 tends to be larger than when the slider 16 moves downward. The motor control unit 60 controls the servo motor 42 so as to reduce the difference between the drive current and the target value. Thus, it is possible to appropriately reduce the load on the slider 16 that changes in accordance with both the vertical movement and the weight of the slider 16.

### Modifications

The above-described embodiment may be modified as follows.

### Modification 1

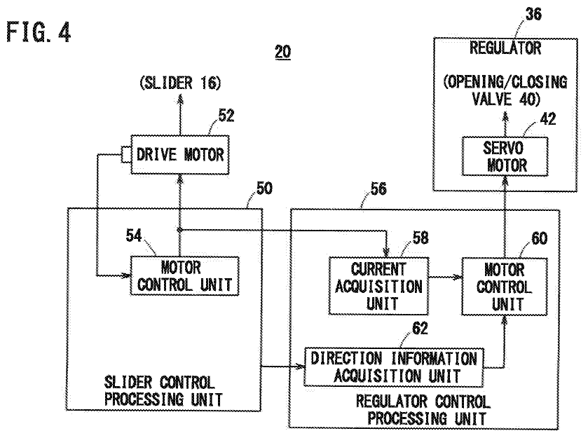

FIG. 4 is a block diagram showing a configuration of the control device 20 according to a first modification. In FIG. 4, the same components as those described in the above embodiment are denoted by the same reference numerals. Moreover, in the present exemplary modification, descriptions that overlap or are duplicative of those stated in the embodiment will be omitted.

In the control device 20 of the present modification, a direction information acquisition unit 62 that acquires direction information indicating the movement direction of the slider 16 is newly provided. The direction information may be a machining program or a command value for the drive motor 52.

The motor control unit 60 of the present modification controls the servo motor 42 of the regulator 36 based on the drive current acquired by the current acquisition unit 58 and the direction information acquired by the direction information acquisition unit 62. Thus, the motor control unit 60 adjusts the pressure of the compressed fluid inside the fluid chamber 38. As a result, the load on the slider 16 can be reduced more finely than in the case where the pressure in the fluid chamber 38 is adjusted based only on the drive current.

For example, when the slider 16 moves in a direction (upward direction) opposite to the gravity direction, the motor control unit 60 increases the pressure in accordance with the drive current. On the other hand, when the slider 16 moves in the gravity direction (downward direction), the motor control unit 60 decreases the pressure in accordance with the drive current. Thus, the load on the slider 16 can be reduced in accordance with changes in both the vertical movement and the weight of the slider 16. As a result, the slider 16 can be moved more smoothly than in the case where the pressure is adjusted only according to the drive current of the slider 16.

When the slider 16 moves in the upward direction, the motor control unit 60 may increase the rate of change at which the pressure is changed in accordance with the drive current, compared to when the slider 16 moves in the downward direction.

### Modification 2

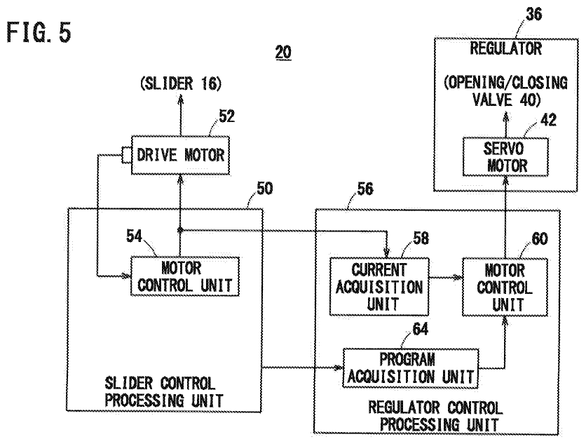

FIG. 5 is a block diagram showing a configuration of a control device 20 according to a second modification. In FIG. 5, the same components as those described in the above embodiment are denoted by the same reference numerals. Moreover, in the present exemplary modification, descriptions that overlap or are duplicative of those stated in the embodiment will be omitted.

In the control device 20 of the present modification, a program acquisition unit 64 that acquires a machining program is newly provided. The program acquisition unit 64 may acquire the machining program stored in a storage unit of the slider control processing unit 50 via the slider control processing unit 50. Alternatively, the program acquisition unit 64 may acauire the machining program stored in a portable memory via a connector to which the portable memory can be connected.

The motor control unit 60 of the present modification controls the servo motor 42 of the regulator 36 based on the drive current acquired by the current acquisition unit 58 and the machining program acquired by the program acquisition unit 64. Thus, the motor control unit 60 adjusts the pressure of the compressed fluid inside the fluid chamber 38. As a result, the load on the slider 16 can be reduced more finely than in the case where the pressure in the fluid chamber 38 is adjusted based only on the drive current.

In the machining program, there are cases where the moving speed in the case where the slider 16 moves without machining a workpiece may be set so as to be faster than the moving speed in the case where the slider 16 moves while a workpiece is being machined. The drive current output to the drive motor 52 tends to increases as the moving speed of the slider 16 increases. Therefore, when the slider 16 moves without machining a workpiece, the motor control unit 60 may increase the rate of change at which the pressure is changed, compared to the case where the slider 16 moves while a workpiece is being machined. As a result, the load on the slider 16 can be reduced according to changes in both the moving speed and the weight of the slider 16. As a result, the slider 16 can be moved more smoothly than in the case where the pressure is adjusted only according to the drive current of the slider 16.

### Modification 3

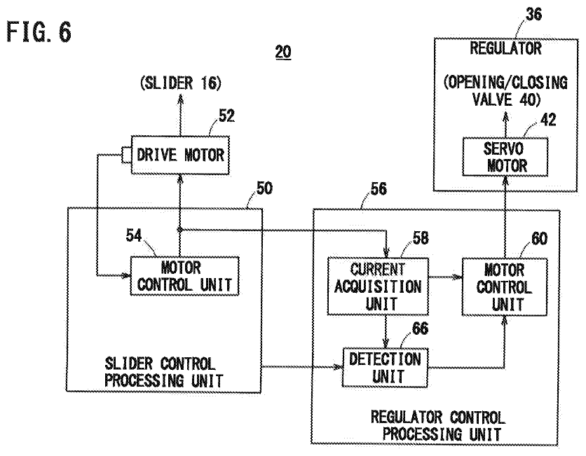

FIG. 6 is a block diagram showing a configuration of a control device 20 according to a third modification. In FIG. 6, the same components as those described in the above embodiment are denoted by the same reference numerals. Moreover, in the present exemplary modification, descriptions that overlap or are duplicative of those stated in the embodiment will be omitted.

In the control device 20 of the present modification, a detection unit 66 that detects abnormality in machining of a workpiece is newly provided. Examples of the case where the detection unit 66 detects abnormality in machining of a workpiece include a case where the drive current acquired by the current acquisition unit 58 exceeds a predetermined threshold value. Alternatively, as a case where the detection unit 66 detects abnormality in machining of a workpiece, there is a case where an emergency stop command output from an emergency stop button is detected. The emergency stop button is provided on the machine tool 10.

In the present modification, when the detection unit 66 detects abnormality in machining of a workpiece, the motor control unit 60 increases the pressure of the compressed fluid inside the fluid chamber 38 to thereby move the slider 16 upward. Thus, even if the slider 16 is brought into an emergency stop, the slider 16 can be retreated to a predetermined retreat position by the fluid balancer 18. As a result, it is possible to prevent an unexpected situation such as damage to the workpiece caused by the slider 16 remaining at the emergency stop position.

### Modification 4

The motor control unit 60 may use a database or mathematical formula to adjust the pressure of the compressed fluid inside the fluid chamber 38. The database or the mathematical formula is stored in a storage unit or the like of the regulator control processing unit 56. Here, control of the motor control unit 60 in a case where the database or the mathematical formula indicates a relationship in which the opening degree of the opening/closing valve 40 decreases as the drive current increases will be described. The motor control unit 60 controls the servo motor 42 such that the opening degree of the opening/closing valve 40 decreases as the drive current acquired by the current acquisition unit 58 increases. That is, the motor control unit 60 increases the pressure of the compressed fluid inside the fluid chamber 38 as the drive current acquired by the current acquisition unit 58 increases. Accordingly, similarly to the above-described embodiment, even when the weight of the slider 16 changes, the load on the slider 16 can be reduced by the fluid pressure corresponding to the changed weight.

### Modification 5

The configuration of the fluid balancer 18 is not limited to the embodiment. For example, the fluid balancer 18 may be configured such that the slider 16 moves together with the shaft 30. Alternatively, the fluid balancer 18 may supply compressed fluid to the fluid chamber 38 from a fluid supply source through a flow path 44 via the shaft 30.

### Modification 6

The above-described embodiment and the modifications may be optionally combined within a range in which no technical inconsistencies occur.

### Invention Obtained from the Embodiment

The invention that can be grasped based on the above description will be described below.

The machine tool (10) includes the slider (16) movable on the guide shaft (14) that extends along the gravity direction. The machine tool (10) includes the fluid balancer (18) configured to reduce the weight of the slider (16) using the compressed fluid; the opening/closing valve (40) provided in the flow path (44) for the compressed fluid supplied from the fluid supply source to the fluid balancer (18), and configured to open and close the flow path (44); the servo motor (42) configured to change the opening degree of the opening/closing valve (40); the current acquisition unit (58) configured to acquire a drive current output to the drive motor (52) configured to drive the slider (16); and the motor control unit (60) configured to adjust the pressure of the compressed fluid inside the fluid balancer (18) by controlling the servo motor (42) based on the drive current.

The pressure inside the fluid balancer (18) is regulated based on the drive current, which tends to vary with the weight of the slider (16), thereby reducing the load on the slider (16) in response to the weight of the slider (16). As a result, the slider (16) can be smoothly moved.

The fluid balancer (18) may include the cylinder (34) extending parallel to the guide shaft (14), and the shaft (30) configured to be inserted into the cylinder (34), the slider (16) may move together with the shaft (30) or the cylinder (34), and the motor control unit (60) may adjust the pressure of the compressed fluid inside the fluid chamber (38) formed between the cylinder (34) and the shaft (30). Thus, the pressure in the fluid balancer (18) can be appropriately adjusted.

The motor control unit (60) may adjust the pressure so as to reduce the difference between the drive current and the target value. This makes it possible to appropriately reduce the load on the slider (16) that varies in accordance with both the movement and the weight of the slider (16).

The motor control unit (60) may increase the pressure as the drive current increases. This makes it possible to appropriately reduce the load on the slider (16) that changes in accordance with the weight of the slider (16).

The machine tool (10) may include the direction information acquisition unit (62) configured to acquire direction information indicating a movement direction of the slider (16), and the motor control unit (60) may adjust the pressure based on the drive current and the direction information. This makes it possible to reduce the load on the slider (16) more finely than in the case where the pressure is adjusted based only on the drive current.

The motor control unit (60) may increase the pressure when the slider (16) moves in the direction of gravity, and may decrease the pressure when the slider (16) moves in the direction opposite to the direction of gravity. This makes it possible to appropriately reduce the load on the slider (16) that varies in accordance with both the movement and the weight of the slider (16).

The machine tool (10) may include the program acquisition unit (64) configured to acquire a machining program, and the motor control unit (60) may adjust the pressure based on the drive current and the machining program. The load on the slider (16) can be reduced more finely than in the case where the pressure is adjusted based only on the drive current.

In a case where the slider (16) moves without machining a workpiece, the motor control unit (60) may increase a rate at which the pressure is changed, compared to a case where the slider (16) moves while the workpiece is being machined. Thus, the load on the slider (16) can be appropriately reduced in accordance with changes in both the moving speed and the weight of the slider (16).

The machine tool (10) may further include the detection unit (66) configured to detect abnormality in machining of a workpiece, and when the detection unit (66) detects the abnormality in machining of the workpiece, the motor control unit (60) may increase the pressure to thereby move the slider (16) in a direction opposite to the gravity direction. Thus, even if the slider (16) is brought into an emergency stop, the slider (16) can be retreated to a predetermined retreat position by the fluid balancer (18). As a result, it is possible to prevent an unexpected situation such as damage to the workpiece caused by the slider (16) remaining at the emergency stop position,

1. A machine tool including a slider configured to be movable on a guide shaft that extends along a gravity direction, the machine tool comprising:
a fluid balancer configured to reduce a weight of the slider using a compressed fluid;
an opening/closing valve provided in a flow path for the compressed fluid supplied from a fluid supply source to the fluid balancer, and configured to open and close the flow path;
a servo motor configured to change an opening degree of the opening/closing valve;
a current acquisition unit configured to acquire a drive current output to a drive motor configured to drive the slider; and
a motor control unit configured to adjust a pressure of the compressed fluid inside the fluid balancer by controlling the servo motor based on the drive current.

2. The machine tool according to claim 1, wherein
the fluid balancer includes a cylinder extending parallel to the guide shaft, and a shaft configured to be inserted into the cylinder,
the slider moves together with the shaft or the cylinder, and
the motor control unit adjusts the pressure of the compressed fluid inside a fluid chamber formed between the cylinder and the shaft.

3. The machine tool according to claim 1, wherein
the motor control unit adjusts the pressure so as to reduce a difference between the drive current and a target value.

4. The machine tool according to claim 1, wherein
the motor control unit increases the pressure as the drive current increases.

5. The machine tool according to claim 1, further comprising a direction information acquisition unit configured to acquire direction information indicating a moving direction of the slider,
wherein the motor control unit adjusts the pressure based on the drive current and the direction information.

6. The machine tool according to claim 5, wherein
the motor control unit increases the pressure when the slider moves in the gravity direction, and decreases the pressure when the slider moves in a direction opposite to the gravity direction.

7. The machine tool according to claim 1, further comprising a program acquisition unit configured to acquire a machining program,
wherein the motor control unit adjusts the pressure based on the drive current and the machining program.

8. The machine tool according to claim 7, wherein
in a case where the slider moves without machining a workpiece, the motor control unit increases a rate at which the pressure is changed, compared to a case where the slider moves while the workpiece is being machined.

9. The machine tool according to claim 1, further comprising a detection unit configured to detect abnormality in machining of a workpiece,
wherein when the detection unit detects the abnormality in machining of the workpiece, the motor control unit increases the pressure to thereby move the slider in a direction opposite to the gravity direction.
